(19) United States
(12) Patent Application Publication
(10) Pub. No.: US 2006/0104784 A1
(43) Pub. Date: May 18, 2006

(54) Apparatus for picking up a defective portion replica

(76) Inventors: Akihiko Hirano, Hitachinaka (JP); Noahito Sato, Hitachi (JP); Hiroshi Sakata, Uchihara (JP); Satoshi Kanno, Hitachi (JP); Takao Shimura, Hitachi (JP); Hirokazu Adachi, Hitachi (JP); Noboru Saitou, Chiyoda (JP)

Correspondence Address: MATTINGLY, STANGER & MALUR, P.C.;ATTORNEYS AT LAW, 104 EAST HUME AVENUE, ALEXANDRIA, VA, 22301, US

(21) Appl. No.: 09/790,879

(22) Filed: Feb. 23, 2001

(30) Foreign Application Priority Data
Aug. 31, 2000 (JP) 2000-263597

(51) Int. Cl. B65G 7/12

(52) U.S. Cl. 414/669

(57) ABSTRACT

There is provided an apparatus for picking up a defective portion replica that can pick up a replica with high accuracy and positively even from a surface of a structure in the water. Within a container part provided at a leading end of a replica pickup part is displaced a deformable member, such as a porous expansion member, which is excellent in adhesion with a replica and which deforms when a replica material is poured into a gap between a surface of a structure and the deformable member. The replica material from the replica material supply nozzle is poured into the gap between the surface of a structure and the porous expansion member and the replica is recovered by making use of adhesion with the porous expansion member.

### BACKGROUND OF THE INVENTION

The present invention relates to an apparatus for picking up a defective portion replica which picks up a replica of a defective portion present on a surface of a structure to be inspected and inspects the occurrence of damage to the structure.

As a conventional inspection apparatus for inspecting an inner surface of a pipe including the picking up of a replica, an inspection apparatus described in JP-A-9-152406 is known. In this known inspection apparatus, an articulated arm is introduced into the interior of a pipe from an inspection hole of the pipe and a replica of an inner surface of the pipe is picked up by a replica pickup tool attached to a leading end of this articulated arm. Furthermore, in an inspection apparatus described in JP-A-8-29306, a parallel link mechanism provided with a kick plate at an leading end thereof is used to pick up a replica by remote operation and a shape is obtained by pressing a pressing member against a surface from which a replica is to be picked up.

In a pickup apparatus for picking up a replica of a structure in a nuclear reactor described in JP-A-7-325184, a mold whose shape is fitted beforehand to the shape of a portion from which a replica is to be picked up is provided and a shape is obtained by pouring a replica material into the mold. In a pickup apparatus for picking up a surface replica from a inner surface of a small-diameter bore, etc., which is described in JP-A-5-302875, there is provided a means by which a frame into which a replica-making liquid is to be poured is provided beforehand, a replica-making liquid is poured into the frame and a replica is picked up by pressing the frame against a surface of a member.

### SUMMARY OF THE INVENTION

With the pickup apparatus described in JP-A-9-152406, remote replica pickup is made possible by the use of an articulated arm. With the pickup apparatus described in JP-A-8-29306, convenient and reliable replica pickup is made possible by the use of a parallel link mechanism. With the pickup apparatus described in JP-A-7-325184, a replica can be picked up from a wide area by increasing the size of a mold. However, underwater uses were not considered in any of the above conventional replica pickup apparatuses and high-precision and accurate pick up of replicas could not be expected when they were used under water.

The object of the present invention is to provide an apparatus for picking up a defective portion replica which can pick up a defective portion replica with high accuracy and positively even from a surface of a structure which is in the water.

According to the present invention, in order to achieve the above object, there is provided an apparatus for picking up a defective portion replica comprising a replica pickup part which comes into close contact with a surface of a structure and which picks up a replica of a defective portion by supplying a replica material to the surface of the structure, wherein the replica pickup part comprises a deformable member which is excellent in adhesion with the replica and which deforms to allow the replica material to be poured into a gap between the surface of the structure and the deformable member, and a replica material supply nozzle for pouring the replica material into the gap between the surface of the structure and the deformable member.

In this case, it is preferred that a porous expansion member may be used as the deformable member and that the replica pickup part may be provided with a container part which houses the deformable member and can come into close contact with the surface of the structure. Furthermore, the replica pickup part has a spring which works in a direction in which the spring presses the container part toward the surface side of the structure. Furthermore, it is preferred that a gap of not less than 0.5 mm be formed between the surface of the structure and a tip of the replica material supply nozzle when the container part is brought into close contact with the surface of the structure.

The replica pickup part is provided with a replica material storage tank, which is connected to the replica material supply nozzle and is filled with the replica material, and a replica material extruding air actuator for extruding the replica material in the replica material storage tank by remote operation. The filling volume of the replica material in the replica material storage tank is set at a volume that allows the replica material to overflow an outer edge of the deformable member.

Furthermore, it is preferred that a remote operation air actuator may be installed and that this air actuator may be provided with a plurality of rotatably installed columns to each of which the replica pickup part is attached.

Furthermore, it is preferred that an under-water camera and a lightening apparatus, which are directed to a portion of the structure from which the replica is to be picked up by the replica pickup part, may be installed in the vicinity of the replica pickup part and that a gap sensor for measuring the distance to a portion of the structure from which the replica is to be picked up by the replica pickup part may be installed in the vicinity of the replica pickup part.

Furthermore, it is preferred that an inclined part which is inclined to the axial direction of the replica material supply nozzle may be formed on the tip of the replica material supply nozzle and that a notched part through which the replica material can flow be formed on the tip of the replica material supply nozzle.

Moreover, it is preferred that there may be provided an observational image processing part which classifies observational images of a plurality of replicas picked up by the replica pickup part into a plurality of regions, binarizes the observational images, and ANDs the binary data of regions corresponding to the mutually same positions of the plurality of replica.

Furthermore, according to the present invention, in order to achieve the above object, there is provided an apparatus for picking up a defective portion replica comprising a replica pickup part which comes into close contact with a surface of a structure and which picks up a replica of a defective portion by supplying a replica material to the surface of the structure. The apparatus for picking up a defective portion replica further comprises: a main arm which moves vertically with respect to the structure; an auxiliary arm which is rotatably installed in the main arm via an air actuator; an air cylinder which is installed to enable the shaft length of the auxiliary arm to be adjusted in the axial direction thereof; a plurality of columns which are rotatably installed on the leading end of the auxiliary arm via another air actuator; a replica pickup part attached to each column; and an apparatus for controlling high-pressure air to each of the actuators and the air cylinder. The replica pickup part comprises a deformable member which is excellent in adhesion with the replica and which deforms to allow the replica material to be poured into a gap between the surface of the structure and the deformable member, and a replica material supply nozzle for pouring the replica material into the gap between the surface of the structure and the deformable member.

The apparatus for picking up a defective portion replica according to the present invention is constituted by a deformable member which is excellent in adhesion with the replica and which deforms to allow the replica material to be poured into a gap between the surface of the structure and the deformable member, and a replica material supply nozzle for pouring the replica material into the gap between the surface of the structure and the deformable member. Therefore, when the replica material is poured into a gap between the surface of the structure and the deformable member, it is poured into the gap while the deformable member is deforming and besides, the replica can be picked up while it is in close contact with the deformable member. Therefore, a replica can be picked up with high accuracy and certainty even from a surface of a structure in the water.

As explained above, the apparatus for picking up a defective portion replica according to the present invention is constituted by a deformable member which is excellent in adhesion with the replica and which deforms to allow the replica material to be poured into a gap between the surface of the structure and the deformable member, and a replica material supply nozzle for pouring the replica material into the gap between the surface of the structure and the deformable member. Therefore, when the replica material is poured into a gap between the surface of the structure and the deformable member, it is poured into the gap while the deformable member is deforming and besides, since the application of the appropriate pressing force to the replica material during curing becomes possible, the accuracy on transferring the replica can be enhanced, the replica can be recovered while it is in close contact with the deformable member. Therefore, a replica can be picked up with high accuracy and positively even from a surface of a structure in the water.

### BRIEF DESCRIPTION OF THE DRAWINGS

These and other features, objects and advantages of the present invention will become more apparent from the following description when taken in conjunction with the accompanying drawings wherein:

FIG. 1 is a side view, partly in section, of an apparatus for picking up a defective portion replica in an embodiment of the present invention,

FIG. 2 is a side view, partly in section, of a replica pickup condition related to the apparatus for picking up a defective portion replica shown in FIG. 1,

FIG. 3 is a side view, partly in section, of a general construction of the apparatus for picking up a defective portion replica shown in FIG. 1,

FIG. 4 is a side view, partly in section, of an apparatus for picking up a defective portion replica in another embodiment of the present invention,

FIG. 5 is a side view, partly in section, of an apparatus for picking up a defective portion replica in still another embodiment of the present invention,

FIG. 6 is a side view, partly in section, of a replica pickup condition related to the apparatus for picking up a defective portion replica shown in FIG. 5,

FIG. 7 is a side view, partly in section, of an apparatus for picking up a defective portion replica in a further embodiment of the present invention,

FIG. 8 is a side view, partly in section, of an apparatus for picking up a defective portion replica in a still further embodiment of the present invention,

FIG. 9 is a side view, partly in section, of an apparatus for picking up a defective portion replica in an additional embodiment of the present invention,

FIG. 10 is a side view of an essential part of an apparatus for picking up a defective portion replica in a still additional embodiment of the present invention,

FIG. 11 is a side view of an essential part of an apparatus for picking up a defective portion replica in a further embodiment of the present invention, and

FIG. 12 is a block diagram of an image processing part of an apparatus for picking up a defective portion replica in a still further embodiment of the present invention.

### DETAILED DESCRIPTION OF PREFERRED EMBODIMENTS

The embodiments of the present invention will be explained below with reference to the accompanying drawings.

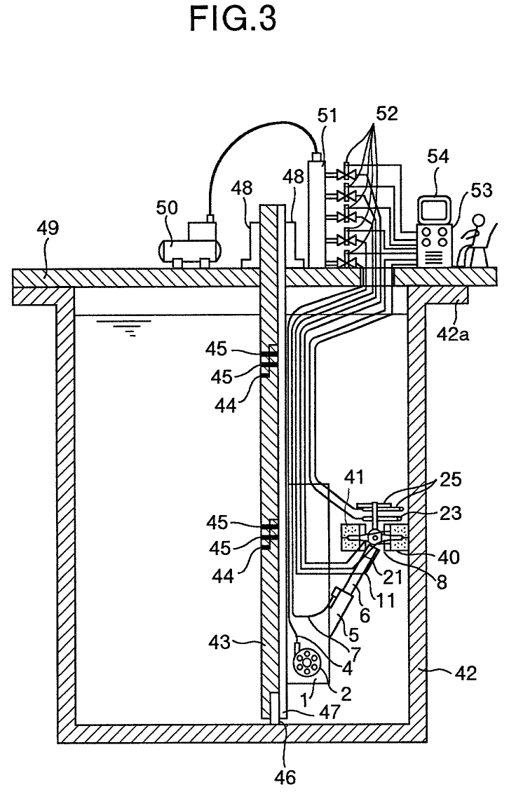

FIG. 3 is a sectional view of an apparatus for picking up a defective portion replica shown in an embodiment of the present invention.

As shown in the figure, in picking up a replica of a structure-container 42 filled with water, a working floor 49 is installed on a flange 42a of the structure-container 42. A pair of guide plate receiving members 48 is installed on the working floor 49, and a guide plate is lowered from the working floor 49 along the guide plate receiving member 48 and is placed within the structure-container 42. In this example, three guide plates 43 with a prescribed length are prepared. These three guide plates are connected with the use of guide plate connecting bolts 45 so that the leading end of the guide plate 43 which is arranged in the lowest position reaches the vicinity of the structure-container 42.

An electromagnet 46 is attached to the leading end of the guide plate 43 which is arranged in the lowest position. The guide plate 43 which is arranged in the lowest position is supported by magnetically fixing the electromagnet 46 to the bottom of the structure-container 42. The on-off control of the electromagnet 46 can be performed through the use of a power source and a controller 53. On the other hand, the top end of the highest guide plate 43 among the three is held by the guide plate receiving member 48 so that it is not displaced laterally. A guide rail 47 is installed along the guide plate 43 and a main arm 1 can move along the guide rail 47. In the figure, the main arm 1 has already moved to within the structure-container 42.

A compressor 50 is installed on the working floor 49. Compressed air from the compressor 50 is fed to a manifold 51. Five outlet sides of the manifold 51 are each provided with a solenoid valve for air 52. When the solenoid valves for air 52, each of which can be independently opened and closed by the operation of the power source and the controller 53, are opened, the replica pickup part 40, 41, which will be described in detail later, is driven by compressed air.

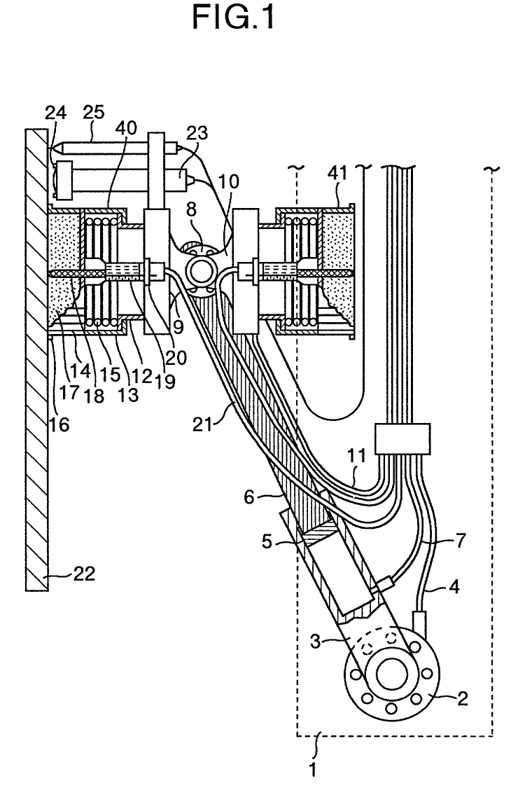

FIG. 1 is an enlarged rear view of an essential part of the apparatus for picking up a defective portion replica shown in FIG. 3.

An end of an auxiliary arm 3 is rotatably connected to the main arm 1 via an air actuator 2 such as a vane-type air actuator, and the angle of the auxiliary arm 3 to the main arm 1 is controlled by high-pressure air fed to the actuator 2 by way of a high-pressure air tube 4. An end of an auxiliary arm 6 is connected to the other end of the auxiliary arm 3 via an air cylinder 5. High-pressure air is fed to the air cylinder 5 via a high-pressure air tube 7 so that the shaft length of the auxiliary arm 6 can be adjusted. An air actuator 8 such as a vane-type air actuator is attached to the other end of the auxiliary arm 6, and a column 9 and a column 10 are installed via the actuator 8. The air actuator 8 can adjust the installation angle of the columns 9 and 10 by high-pressure air fed by way of a high-pressure air tube 11.

A replica pickup part 40 is attached to the column 9. In detail, the replica pickup part 40 is of such a construction that a container part 12 is connected to the column 9 and a container part 14, which is provided with a container skirt 16 at the leading end thereof, is connected via a container part 13 which is movably fitted to the container part 12, wherein the container part 14 is pressed against a structure 22 by a spring 15 disposed between the container parts 12 and 13.

The container part 14 is filled with a porous expansion member 17 and a replica material supply nozzle 18 pierces the porous expansion member 17 in almost the center position thereof. The replica material supply nozzle 18 is connected at its one end to a replica material storage tank 19 and a replica material extruding air actuator 20. A nozzle is formed near the structure 22 or at the other end of the replica material supply nozzle 18. For the other column 10 also, a replica pickup part 41 is constructed in quite the same manner and a detailed explanation is omitted herein.

Furthermore, to the column 9 are attached an underwater camera 23, a ring light 24 and a gap sensor 25 in a parallel relation to the replica pickup part 40. These are connected via cables to the power source and the controller 53 shown in FIG. 3. For the column 10 also, an underwater camera 23, a ring light 24 and a gap sensor 25 are similarly installed although a detailed illustration is omitted.

Next, the work of picking up a replica from the structure 22 by means of the above apparatus for picking up a defective portion replica will be explained.

As shown in FIG. 3, after the installation of the apparatus for picking up a defective portion replica, the surface of the structure 22 is surveyed. In other words, a portion from which a replica is to be picked up is searched for by remotely observing the structure 22 displayed by the underwater camera 23 on a monitor 54, which is shown in FIG. 3, while lightening it up by means of the ring light 24. When such an object portion has been found, the distance between the surface of the structure 22 and the skirt 16 of the container is determined by the gap sensor 25 and displayed on the monitor 54 shown in FIG. 3, and the actuator 2, air cylinder 5, air actuator 8, etc., are remotely driven while checking the distance so that the skirt 16 of the container comes into contact with the surface of the structure 22. In this manner the position, direction of rotation, and vertical and horizontal positions of the container skirt 16 of the container part 14 are controlled in an arbitrary manner and, as shown in FIG. 1, the container skirt 16 is brought into close contact with the structure 22.

At this time, the container part 14 is supported by the column 9 via the spring 15 and, therefore, it is possible to satisfactorily bring the container skirt 16 into contact with the surface of the structure 22 by desirably setting the distance determined by the gap sensor 25. Furthermore, to prevent the supplied replica material from leaking to outside the replica pickup part 40, with the result that broken pieces, etc., might flow out into the surrounding water, the container part 14 and container skirt 16 are each fabricated from a soft material. Therefore, the ends of the open surfaces of container part 14 and container skirt 16 are in close contact with the surface of the structure 22.

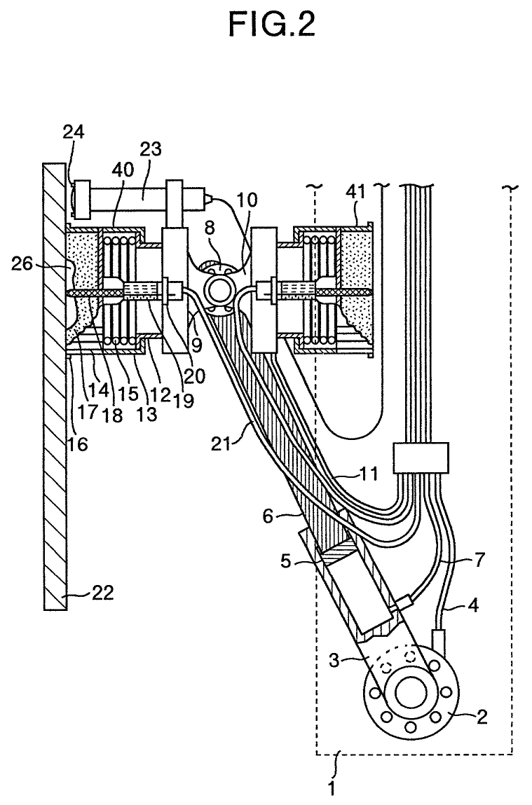

After that, when controlled high-pressure air is fed through a high-pressure air tube 21, the replica material in the replica material storage tank 19 is fed to the replica material supply nozzle 18 by the replica material extruding air actuator 20 and is delivered from the tip of the replica material supply nozzle 18. After the replica material is extruded into the gap between the structure 22 and the porous expansion member 17, the replica material solidifies as the replica indicated by numeral 26 in FIG. 2 between the structure 22 and the porous expansion member 17. At this time, the volume of the replica material stored in the replica material storage tank 19 is optimally determined and besides the porous expansion member 17 is given appropriate adhesion to the structure 22 and, therefore, the replica material does not spread out so that it could reach the container skirt 16.

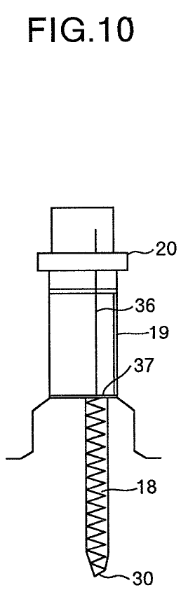

Usually, the replica material solidifies when two or more kinds of liquids are mixed. However, the liquids are separated in a steady state and they are mixed and delivered only when the replica material is to be supplied. For example, the internal construction of the replica material storage tank 19 and replica material supply nozzle 18 is such that, as its details are shown in FIG. 10, which will be described later, a plurality of kinds of liquids are divided by providing a membrane 36 within the replica material storage tank 19 and, at the same time, a membrane 37 is provided on the side of the replica material supply nozzle 18 in the replica material storage tank 19. The strength of the membrane 37 is such that the membrane 37 is broken when high-pressure air is fed to the replica material supply nozzle 18 by the replica material extruding air actuator 20. Therefore, the membrane 37 is broken at the start of supply of the replica material, with the result that the replica material flows into the replica material supply nozzle 18 and solidifies.

Furthermore, because the container skirt 16 and the structure 22 are almost in close contact with each other, the surrounding water does not enter the porous expansion member 17 after the supply of the replica material and the replica 26 does not come into contact with the surrounding water.

After that, when the replica 26 is recovered, by operating the actuator 2, etc. so that the container part 14, etc., are driven and separated from the structure 22, the replica 26, along with the porous expansion member 17, can be positively separated from the surface of the structure 22, because the replica 26 is in close contact with the porous expansion member 17 with sufficient strength by being sufficiently entangled in the porous expansion member 17.

Subsequently, when replica pickup is performed in another place of the structure 22 or when another replica is continuously picked up from the same place, the air actuator 8 is operated so that the columns 9 and 10 are rotated by 180 degrees and driven to replace with each other, the replica pickup part 41 on the side of the column 10 is then caused to become opposite to the structure 22, and the second replica pickup is performed by the same procedure as with the first replica pickup.

After that, the actuator 2, etc. are operated so that the replica pickup part 40, such as the container part 14, etc., are driven and separated from the structure 22, whereby the auxiliary arms 3 and 6 are housed in the main arm 1 and the main arm 1 is caused to travel along the guide rail 47 in order to allow the replica 26 to be recovered.

The above apparatus for picking up a defective portion replica has a pair of columns 9 and 10, which can be switched over between the two by a switching mechanism, such as the air actuator 8, enabling continuous replica pickup to be performed. Furthermore, the arrangement of the porous expansion member 17 in the vicinity of the replica material supply nozzle 18 enables the replica material supplied from the replica material supply nozzle 18 to be delivered to between the structure 22 and the porous expansion member 17 and to be recovered by being fixed to the porous expansion member 17. The same recovery applies also to a case where a deformable member such as an elastic member is used in place of the porous expansion member 17. Because the container member 14 is elastically supported by the spring 15 in a way that it can move in a direction departing from the surface of the structure 22, it is possible to effectively bring the container skirt 16 of the container part 14 into close contact with the surface of the structure 22 by operating the air actuator 8, etc., thereby enabling the replica 26 in good condition to be obtained.

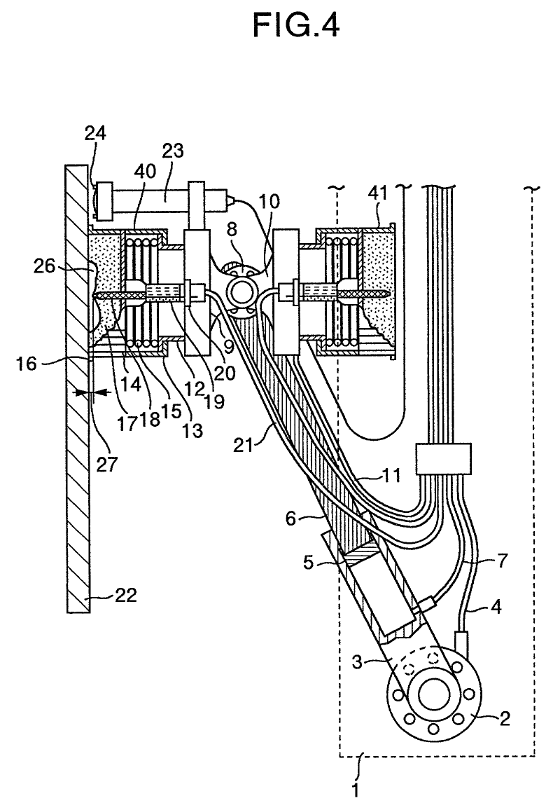

FIG. 4 is a side view, partly in section, of an apparatus for picking up a defective portion replica in another embodiment of the present invention. Equivalents for parts of the embodiment shown in FIG. 1 are given same reference characters and their detailed descriptions are omitted by describing only differences.

In this embodiment, the position of the tip of the replica material supply nozzle 18 is appropriately set and when the container skirt 16 is brought into close contact with the structure 22 under an appropriate pressurizing force on the basis of the gap sensor 25, a gap 27 of not less than 0.5 mm is formed between the tip of the replica material supply nozzle and the surface of the structure 22.

It is also possible to dispose the replica material supply nozzle 18 in this state so that a gap of not more than 0.5 mm between the nozzle tip and the structure 22. In the case of this positional relation, however, there is a possibility that the replica material supply nozzle 18 may make a hole in the center of a replica 26 that is finally obtained and hence it might be thought that the replica 26 does not correctly reflect the presence of a defective portion. However, as described above, when a gap 27 of not less than 0.5 mm is formed between the tip of the replica material supply nozzle 18 and the structure 22, this means that the replica material is supplied also to between the tip of the replica material supply nozzle 18 and the structure 22, with the result that a replica 26 more accurately reflecting the condition of this portion can be obtained.

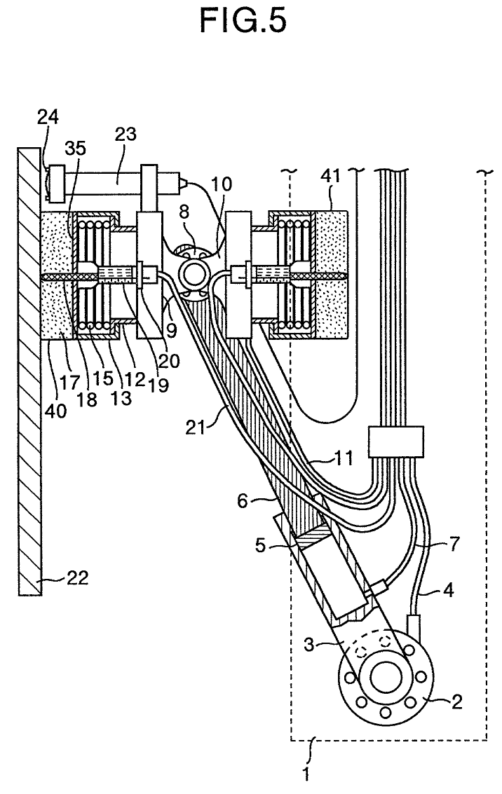

FIG. 5 is a side view, partly in section, of an apparatus for picking up a defective portion replica in still another embodiment of the present invention. Equivalents for parts of the embodiment shown in FIG. 1 are given same reference characters and their detailed descriptions are omitted by describing only differences.

In this embodiment, the container part 14 installed on the side of the surface of the structure 22 shown in FIG. 1 is removed and the porous expansion member 17 is directly attached to a plate-like member 35 connected to the side of the column 9.

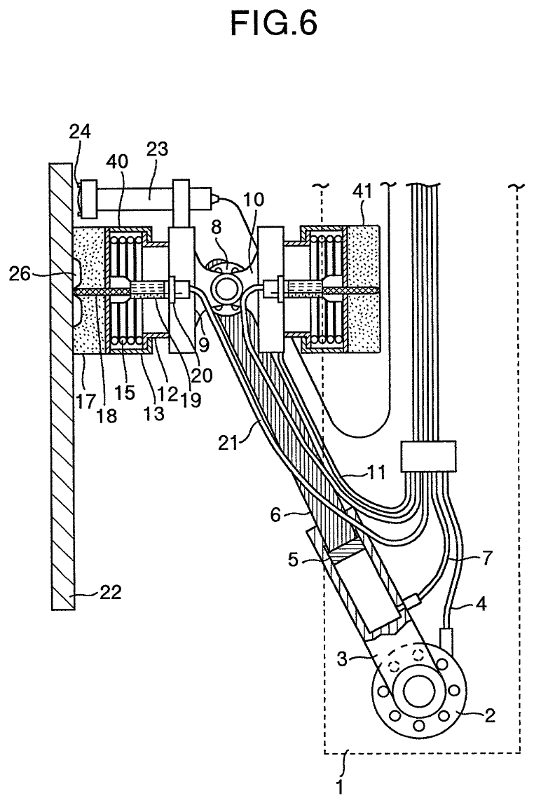

When in picking up a replica, the column 9 is arranged in a prescribed position as with the previous embodiment, the porous expansion member 17 is brought by the spring 15 into close contact with the surface of the structure 22 under a prescribed pressurizing force. Therefore, when high-pressure air is fed in this condition to the replica material extruding air actuator 20 through a high-pressure air tube 21, the replica material within the replica material storage tank 19 is extruded through the replica material supply nozzle 18 and the replica 26 is obtained as shown in FIG. 6. In other words, it is possible to obtain the replica 26 which does not protrude from the porous expansion member 17 even in the nonexistence of the container part 14 and which is entangled in the porous expansion member 17.

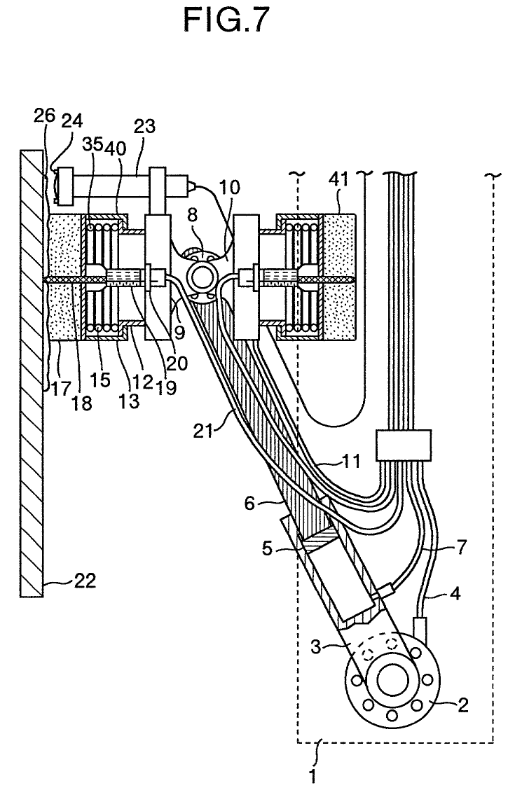

FIG. 7 is a side view, partly in section, of an apparatus for picking up a defective portion replica in a further embodiment of the present invention. Equivalents for parts of the embodiment shown in FIG. 5 are given same reference characters and their detailed descriptions are omitted by describing only differences.

In this embodiment, the volume of replica material supplied at a time, which is extruded from the replica material storage tank 19 through the replica material supply nozzle 18, is larger than with the above embodiment shown in FIG. 5. For example, by increasing the inner volume of the replica material storage tank 19 to not less than 130% of a proper quantity in which the replica material does not overflow the container part 14, it is possible to consciously cause the replica to protrude from the plate-like member.

When the volume of replica material supplied at a time, which is extruded from the replica material storage tank 19 through the replica material supply nozzle 18, is larger than with the above embodiment shown in FIG. 5, the replica material protrude from the outer edge of the porous expansion member 17 as shown in FIG. 7 and a replica 26 of large area is obtained. The replica 26 of large area comes into contact with the surrounding water in its outer region. However, because a portion of the replica which contains water and has bubbles is pushed out to the periphery, an accurate replica containing few bubbles can be obtained in the center from which the replica is to be picked up. In this case also, because a replica 26 of large area is in close contact with the porous expansion member 17 by being entangled therein, the replica 26 can be positively recovered.

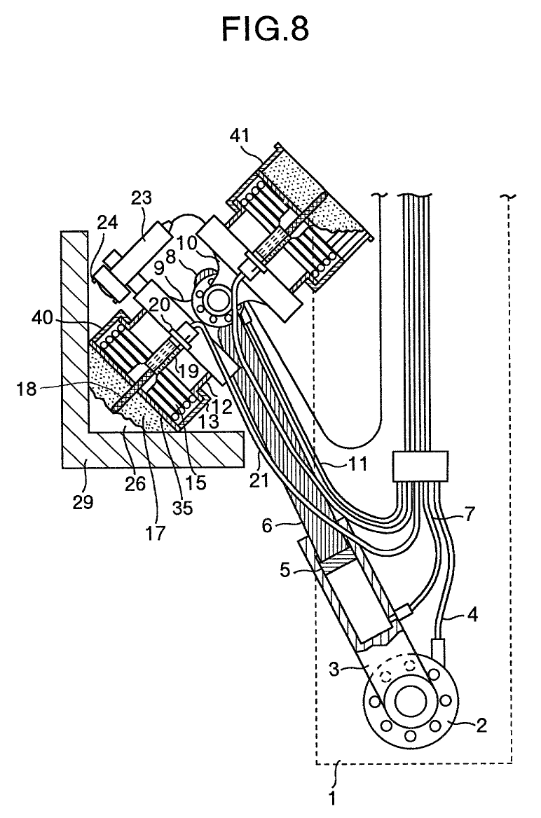

FIG. 8 is a side view, partly in section, of an apparatus for picking up a defective portion replica in a still further embodiment of the present invention. Equivalents for parts of the embodiment shown in FIG. 5 are given same reference characters and their detailed descriptions are omitted by describing only differences.

In this embodiment, the apparatus for picking up a defective portion replica is applied to a case where the surface contour of the structure 22 from which a defective portion replica it to be picked up is complex as with a corner portion 29. In this example, the container part 14 is removed and a porous expansion member 17 the ends of which taper to suit the corner portion 29 is directly fixed to a mounting member 35. The replica pickup part 41 provided with the container part 14 attached to the column 10 in consideration of replica pickup from another portion of the structure 22 is of the same construction as in the above embodiment.

When the surface contour of the structure 22 from which a replica is to be picked up is complex as with the corner portion 29, it is also possible to form the shape of the container 14 so that it matches the contour of the corner portion 29. However, if a porous expansion member 17 as shown in the figure is prepared without using the container part, replica pickup in a portion of complex shape is possible by making use of the adaptability of the porous expansion member 17 due to its deformation.

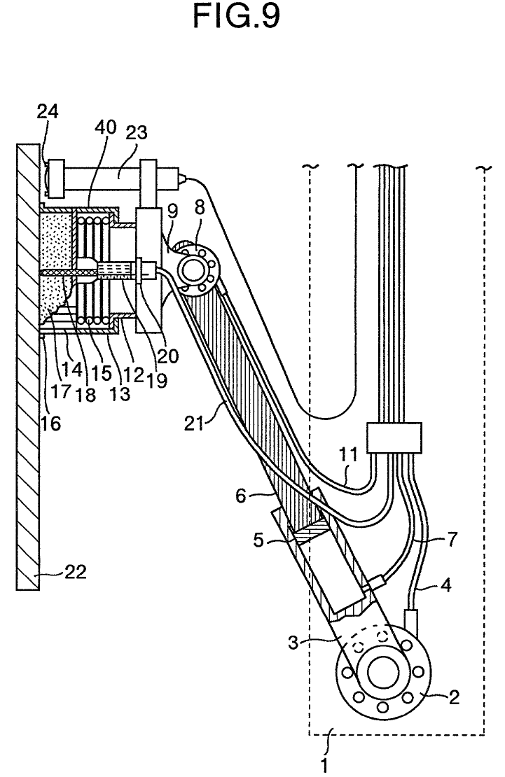

FIG. 9 is a side view, partly in section, of an apparatus for picking up a defective portion replica in an additional embodiment of the present invention. Equivalents for parts of the embodiment shown in FIG. 1 are given same reference characters and their detailed descriptions are omitted by describing only differences.

In this embodiment, the apparatus for picking up a defective portion replica is applied to a case where a plurality of replicas are not picked up from the same position of the structure 22 and only one replica is picked up, and the parts on the column 10 shown in FIG. 1 are omitted. The column 9 is attached to the air actuator 8 and the container part 14, etc., are attached only to the column 9. Therefore, the makeup and operation of the apparatus for picking up a defective portion replica can be simplified.

FIG. 10 is a side view of an essential part of an apparatus for picking up a defective portion replica in a still additional embodiment of the present invention.

The replica material supply nozzle 18 has a tip 30 inclined to the axis. The tip of the replica material supply nozzle 18 is caused to approach the structure 22 or to be pressed against the structure 22. However, because the nozzle tip 30 is inclined, there is no possibility that the replica material could not be easily ejected.

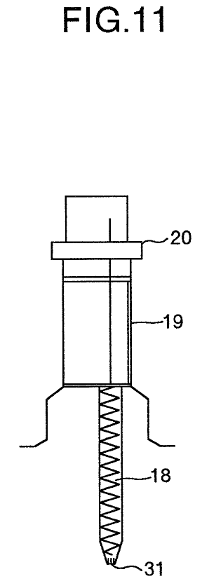

FIG. 11 is a side view of an essential part of an apparatus for picking up a defective portion replica in a further embodiment of the present invention.

The replica material supply nozzle 18 in this embodiment has a notch 31 formed on its tip. As with the embodiment shown in FIG. 10, the tip of the replica material supply nozzle 18 is caused to approach the structure 22 or to be pressed against the structure 22. However, because the notch 31 is formed on the tip, the replica material within the replica material storage tank 19 shown in the figure is supplied also from the notch 31 and there is no possibility that the replica material could not be easily ejected.

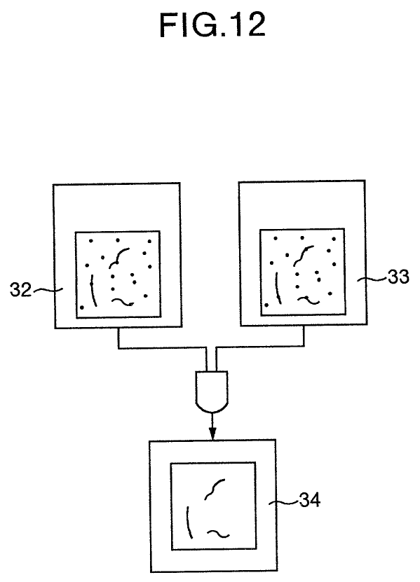

FIG. 12 is a block diagram of an image processing part of an apparatus for picking up a defective portion replica in a still further embodiment of the present invention.

In the embodiment shown in FIG. 1, a plurality of replicas can be picked up from the same position by switching between the column 9 and the column 10. There is provided an image processing part which divides observational images of a plurality of replicas picked up from the same position into microregions, binarizes the observational images, and ANDs the binary data of microregions 32 and 33 corresponding to the mutually same positions of the plurality of replicas. Therefore, it is possible to obtain a high-accuracy observational image of damage from which data on bubbles, etc. other than surface damage is excluded and, therefore, more accurate judgments can be passed.

In a case where the above apparatus for picking up a defective portion replica is applied to replica pickup from a structure in a nuclear reactor, there is a possibility that during replica pickup an activated clad adhering to a surface of the structure may be included. In this case, it is possible to secondarily pick up an unactivated replica from the replica which has been first picked up and to inspect the unactivated replica.

Incidentally, each of the above embodiments was described in a case where a replica or replicas are picked up from a structure 22 under the water. However, the apparatus for picking up a defective portion replica of the present invention can also be used in other environments. Furthermore, in each of the above embodiments, adhesion to the porous expansion member 17 is made use of in order to recover the replica 16. However, any of the embodiments is not limited to the use of the porous expansion member 17 and it is possible to use a deformable member which is excellent in adhesion with the replica 26 and which deforms to allow the replica material to be poured into a gap between the surface of the structure 22 and the deformable member.

What is claimed is:

1. An apparatus for picking up a defective portion replica comprising a replica pickup part which comes into close contact with a surface of a structure and which picks up a replica of a defective portion by supplying a replica material to the surface of the structure, wherein said replica pickup part comprises a deformable member which is excellent in adhesion with said replica and which deforms to allow said replica material to be poured into a gap between the surface of the structure and said deformable member, and a replica material supply nozzle for pouring said replica material into the gap between the surface of the structure and said deformable member.

2. An apparatus for picking up a defective portion replica according to claim 1, wherein a porous expansion member is used as said deformable member and said replica pickup part is provided with a container part which houses said deformable member and can come into close contact with the surface of the structure.

3. An apparatus for picking up a defective portion replica according to claim 2, wherein said replica pickup part has a spring which works in a direction in which said spring presses said container part toward the surface side of the structure.

4. An apparatus for picking up a defective portion replica according to claim 2, wherein a gap of not less than 0.5 mm is formed between the surface of the structure and a tip of said replica material supply nozzle when said container part is brought into close contact with the surface of the structure.

5. An apparatus for picking up a defective portion replica according to claim 1, wherein said replica pickup part is provided with said replica material storage tank, which is connected to said replica material supply nozzle and is filled with said replica material, and a replica material extruding air actuator for extruding said replica material in said replica material storage tank by remote operation.

6. An apparatus for picking up a defective portion replica according to claim 5, wherein the filling volume of said replica material in said replica material storage tank is set at a volume that allows said replica material to overflow an outer edge of said deformable member.

7. An apparatus for picking up a defective portion replica according to claim 1, wherein a remote operation air actuator is installed and said air actuator is provided with a plurality of rotatably installed columns to each of which said replica pickup part is attached.

8. An apparatus for picking up a defective portion replica according to claim 1, wherein an underwater camera and a lightening apparatus, which are directed to a portion of the structure from which said replica is to be picked up by said replica pickup part, are installed in the vicinity of said replica pickup part.

9. An apparatus for picking up a defective portion replica according to claim 1, wherein a gap sensor for measuring the distance to a portion of the structure from which said replica is to be picked up by said replica pickup part is installed in the vicinity of said replica pickup part.

10. An apparatus for picking up a defective portion replica according to claim 1, wherein an inclined part which is inclined to the axial direction of said replica material supply nozzle is formed on the tip of said replica material supply nozzle.

11. An apparatus for picking up a defective portion replica according to claim 1, wherein a notched part through which said replica material can flow is formed on the tip of said replica material supply nozzle.

12. An apparatus for picking up a defective portion replica according to claim 1, wherein there is provided an observational image processing part which classifies observational images of a plurality of said replicas picked up by said replica pickup part into a plurality of regions, binarizes the observational images, and ANDs the binary data of regions corresponding to the mutually same positions of a plurality of said replica.

13. An apparatus for picking up a defective portion replica comprising: a replica pickup part which comes into close contact with a surface of a structure and which picks up a replica of a defective portion by supplying a replica material to the surface of the structure; a main arm which moves vertically with respect to the structure; an auxiliary arm which is rotatably installed in said main arm via an air actuator; an air cylinder which is installed to enable the shaft length of said auxiliary arm to be adjusted in the axial direction thereof; a plurality of columns which are rotatably installed on the leading end of said auxiliary arm via another air actuator; a replica pickup part attached to each column; and an apparatus for controlling high-pressure air to each of said actuators and said air cylinder, wherein said replica pickup part is excellent in adhesion with said replica and comprises a deformable member which deforms to allow said replica material to be poured into a gap between the surface of the structure and the deformable member and a replica material supply nozzle for pouring said replica material into the gap between the surface of the structure and said deformable member.
